(19) United States
(12) Patent Application Publication
(10) Pub. No.: US 2014/0137956 A1
(43) Pub. Date: May 22, 2014

(54) HYDRAULIC CONTROL VALVE FOR CONSTRUCTION MACHINERY

(71) Applicant: Jin-Wook Kim, Changwon-si (KR)

(72) Inventor: Jin-Wook Kim, Changwon-si (KR)

(73) Assignee: VOLVO CONSTRUCTION EQUIPMENT AB, Eskilstuna (SE)

(21) Appl. No.: 14/129,021

(22) PCT Filed: Jun. 27, 2011
(86) PCT No.: PCT/KR2011/004659

§ 371 Date: Dec. 23, 2013

(51) Int. Cl. F15B 13/042; F15B 13/08

(52) U.S. Cl. CPC F15B 13/0426; F15B 13/08
USPC 137/488; 137/614

(57) ABSTRACT

Provided is a hydraulic control valve in which a center bypass passage is not blocked, but is unloaded when a swing and an arm are operated at the same time to prevent the pressure in a hydraulic pump from being increased. The hydraulic control valve includes: a hydraulic pump connected to an engine; a swing spool disposed upstream of a center bypass passage communicating with a discharge passage of the hydraulic pump to control the operation and stopping of a swing motor and directional switching of the swing motor when switched; an arm spool disposed downstream of the bypass passage to control the operation and stopping of an arm cylinder and directional switching of the arm cylinder when switched; and a center bypass control valve disposed within the arm spool, the center bypass control valve being switched by a discharge flow pressure of the hydraulic pump which is increased when a multi operation for simultaneously operating the swing and the arm is performed, and unloading the increased swing side pressure to the center bypass passage when switched.

### FIELD OF THE INVENTION

The present invention relates to a hydraulic control valve for a construction machine. More particularly, the present invention relates to a hydraulic control valve for a construction machine in which a hydraulic fluid discharged from a high-load hydraulic pump is unloaded to the center bypass path without any interception of the center bypass path during a combined operation in which a swing manipulation and a manipulation of a work apparatus such as an arm or the like are simultaneously performed, thereby preventing the excessive increase in the pressure of the hydraulic pump.

### BACKGROUND OF THE INVENTION

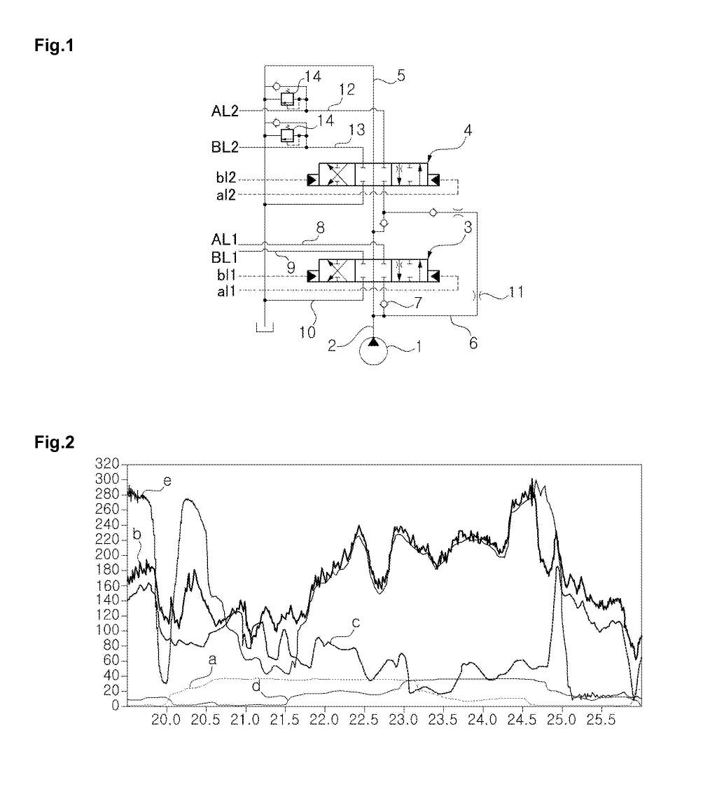

In general, a hydraulic control valve for a construction machine in accordance with the prior art as shown in FIG. 1 includes:

a hydraulic pump 1 connected to an engine (not shown);

a swing spool 3 installed on an upstream side of a center bypass path 5 that fluidically communicates with a discharge flow path 2 of the hydraulic pump 1 and configured to be shifted to control a start, a stop, and a direction change of a swing motor (not shown); and

an arm spool 4 installed on a downstream side of the center bypass path 5 and configured to be shifted to control a start, a stop, and a direction change of an arm cylinder (not shown).

The discharge flow path 2 consists of the center bypass path 5 fluidically communicating therewith and a parallel line 6 that is branchedly connected thereto.

A non-explained reference numeral 14 denotes a relief valve that is installed on the cylinder lines 12 and 13, respectively.

The swing spool 3 is shifted in a left direction on the drawing sheet by a pilot signal pressure supplied to a port (al1) to perform a swing operation of the construction machine. In this case, a hydraulic fluid discharged from the hydraulic pump 1 is supplied to a port (AL1) via a line 8 after sequentially passing through a check valve 7 installed on an inlet line 8 of the swing spool 3 and the shifted swing spool 3 so that the swing motor can be driven to swing an upper swing structure of the construction machine.

At this time, since the hydraulic fluid returned from the swing motor is supplied to a port (BL1), it is returned to a hydraulic tank through a return line 10 after passing through the shifted swing spool 3 via a line 9.

Like this, a sufficient start pressure is needed to drive the hydraulic motor as an inertia unit. In other words, a line is made short sufficiently which interconnects the hydraulic pump 1 to the swing motor in the design of the swing spool 3 so as to increase the pressure of the hydraulic pump 1.

In the meantime, in the case where a manipulation of a work apparatus such as an arm having a relatively low load and a swing manipulation are performed simultaneously, all the hydraulic fluid discharged from the hydraulic pump 1 is supplied to the arm side with a relatively low load, and thus the hydraulic fluid is not supplied to the swing side.

Thus, the conventional hydraulic control valve is a hydraulic system in which an orifice 11 is installed on the parallel line 6 along which the hydraulic fluid is supplied to the arm side so that the flow rate of the hydraulic fluid supplied to the arm side is restricted and simultaneously the swing operation is preferentially performed in the entire hydraulic system, and as a result, the pressure of the hydraulic pump 1 is increased due to the interception of the center bypass path 5 according to the shift of the arm spool 4 to cause the hydraulic fluid to be preferentially be supplied to the swing motor in conformity with the start pressure.

In the case where the arm is manipulated alone, the hydraulic fluid is supplied to the arm spool 4 via the orifice 11 of the parallel line 6, and thus there occur an increase in the pressure of the hydraulic pump 1 and a loss of energy. Like this, since the orifice 11 is used to ensure that the swing operation is preferentially performed, the pressure of the hydraulic pump 1 is increased cause a loss of energy.

As shown in a graph of FIG. 2, when an arm-in pilot signal pressure is supplied to the arm spool 4 to cause the arm spool 4 to be shifted, a pressure (b) of the hydraulic pump 1 side is formed in a similar pattern as a pressure (c) of the arm side. Thereafter, when a swing pilot signal pressure (d) is supplied to the swing spool 3, the pressure of the hydraulic pump 1 is formed in a pattern in which it is increased up to the same pressure (300 Kgf/cm²) as the swing side load (e). In this case, the arm side pressure (c) maintains the load in the range of a relatively low pressure (60-80 Kgf/cm²).

Thus, the pressure of the hydraulic pump 1 follows a high swing pressure during the swing operation while the arm-in side load forms a relatively low pressure. As a result, an excessive loss of pressure occurs in the hydraulic pump 1 to cause a loss of energy, leading to a deterioration in a fuel efficiency.

In a negative control system, a direction switching valve is held in a neutral position and the hydraulic fluid from the hydraulic pump is unloaded to the center bypass path of the control valve so that the discharge flow rate of the hydraulic pump is maintained minimally. On the other hand, when at least one control valve is switched, the unloaded hydraulic fluid passing through the center bypass path is intercepted and the pressure of the hydraulic pump is increased while increasing the discharge flow rate of the hydraulic pump.

In this case, since a high drive pressure is needed at an initial stage to drive or stop the inertia unit such as the swing motor, there occurs the case in which the pressure of the relief valve is increased. Thus, since a high load pressure on the swing side has an effect on the control valve system, the pressure is further increased due to an increase in the discharge flow rate according to a manipulation of the control valve during a combined operation in which a swing drive or manipulation and a manipulation of a hydraulic actuator such as arm cylinder or the like are performed.

For this reason, a horsepower much higher than a proper horsepower required by the construction machine is used, leading to a deterioration in a fuel efficiency and thus causing an excessive loss of energy. Also, in a positive control system, since the discharge flow rate of the hydraulic pump is increased according to a manipulation amount of the control valve, the pressure of the hydraulic pump is also increased excessively to cause a loss of energy.

### DETAILED DESCRIPTION OF THE INVENTION

### Technical Problems

Accordingly, the present invention has been made to solve the aforementioned problem occurring in the prior art, and it is an object of the present invention to provide a hydraulic control valve for a construction machine in which a hydraulic fluid discharged from a high-load hydraulic pump is unloaded without any interception of the center bypass path on the arm side during a combined operation in which a swing manipulation and a manipulation of a work apparatus such as an arm or the like are simultaneously performed, thereby preventing the excessive increase in the pressure of the hydraulic pump to reduce a loss of energy, and thus improving a fuel efficiency.

### Technical Solution

To accomplish the above object, there is provided a hydraulic control valve for a construction machine in accordance with an embodiment of the present invention [symbol] ,

a hydraulic pump connected to an engine;

a swing spool installed on an upstream side of a center bypass path that fluidically communicates with a discharge flow path of the hydraulic pump and configured to be shifted to control a start, a stop, and a direction change of a swing motor;

an arm spool installed on a downstream side of the center bypass path and configured to be shifted to control a start, a stop, and a direction change of an arm cylinder; and

a center bypass control valve installed within the arm spool, the center bypass control valve being configured to be shifted by a pressure of a hydraulic fluid discharged from the hydraulic pump, which is increased during a combined operation in which a swing manipulation and an arm manipulation are simultaneously performed, and configured to unload an increased pressure on the swing side to the center bypass path 5 during the shift thereof.

In accordance with a preferred embodiment of the present invention, the set pressure of the center bypass control valve may be set by an arm load pressure and is controlled to be linearly increased by a start pressure on the swing side according to a swing pilot pressure during the swing operation.

The center bypass control valve includes:

a sleeve installed within the arm spool and having a flow path formed therein so as to fluidically communicate with the discharge flow path of the hydraulic pump;

a first piston slidably installed within the sleeve and configured to be shifted to maintain the arm side load pressure through unloading of a part of the discharged hydraulic fluid on the hydraulic pump side to the center bypass path during the combined operation in which the swing manipulation and the arm manipulation are simultaneously performed;

a second piston configured to be in close contact with one end of the first piston and to be shifted to press the first piston by the load pressure which is variably increased depending on a swing side pilot pressure that is additionally applied to the arm side load pressure during the combined operation in which the swing manipulation and the arm manipulation are simultaneously performed; and

a third piston elastically installed on the other end of the first piston by a valve spring.

The set pressure of the valve spring that supports the third piston is set to be larger than the load pressure on the hydraulic pump side during the arm operation and is set to be smaller than the load pressure on the hydraulic pump during the swing operation.

A pair of center bypass paths, which are formed in a bridge shape to fluidically communicate with each other in the hydraulic control valve so that they fluidically communicate with the discharge flow path of the hydraulic pump 1, fluidically communicate with the center bypass path that fluidically communicates with the discharge flow path of the hydraulic pump 1 via a path formed on the arm spool and the center bypass control valve.

The hydraulic pump is controlled by a positive control system that controls the discharge flow rate of the hydraulic pump in proportion to the shift amount of the hydraulic control valve that is installed in the center bypass path.

The hydraulic pump is controlled by a negative control system that controls the discharge flow rate of the hydraulic pump in reverse proportion to the pressure of the discharged hydraulic fluid, which is formed by a pressure forming means installed on the downstream side of the center bypass path.

### Advantageous Effect

The hydraulic control valve for a construction machine in accordance with embodiments of the present invention as constructed above has the following advantages.

The center bypass control valve is installed within the control valve spool on the arm side so that a hydraulic fluid discharged from a high-load hydraulic pump is unloaded to the center bypass path through the center bypass control valve during a combined operation in which a swing manipulation and a manipulation of a work apparatus such as an arm or the like are simultaneously performed so as to reduce the pressure of the discharged hydraulic fluid, thereby reducing the high load pressure generated from the hydraulic pump, and thus decreasing a loss of energy, leading to improvement of a fuel efficiency.

### BRIEF DESCRIPTION OF THE INVENTION

The above objects, other features and advantages of the present invention will become more apparent by describing the preferred embodiments thereof with reference to the accompanying drawings, in which:

FIG. 1 is a circuit diagram showing a hydraulic control valve for a construction machine in accordance with the prior art;

FIG. 2 is a graph showing a pressure during a combine operation in which a swing manipulation and an arm manipulation are simultaneously performed in a hydraulic control valve for a construction machine in accordance with the prior art;

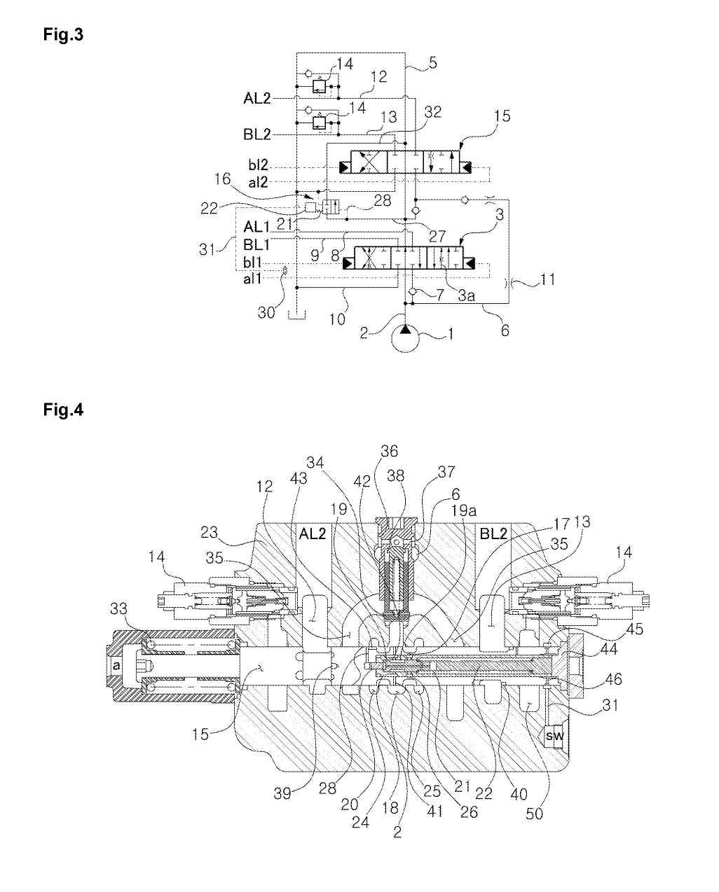

FIG. 3 is a circuit diagram showing a hydraulic control valve for a construction machine in accordance with the present invention; and

FIG. 4 is a cross-sectional view showing a hydraulic control valve for a construction machine in accordance with an embodiment of the present invention.

### EXPLANATION ON REFERENCE NUMERALS OF MAIN ELEMENTS IN THE DRAWINGS

1: hydraulic pump
3: swing spool
5: center bypass path
7: check valve
9: line
11: orifice
13: cylinder line
15: arm spool
17: flow path
19: first piston
21: valve spring
23: hydraulic control valve
25: center bypass path
27: line
31: line
33: valve spring
35: parallel line
37: orifice
39: spool notch
41: flow path
43: spool notch
45: pocket

### PREFERRED EMBODIMENTS OF THE INVENTION

Now, preferred embodiments of the present invention will be described in detail with reference to the accompanying drawings. The matters defined in the description, such as the detailed construction and elements, are nothing but specific details provided to assist those of ordinary skill in the art in a comprehensive understanding of the invention, and the present invention is not limited to the embodiments disclosed hereinafter.

A hydraulic control valve for a construction machine in accordance with an embodiment of the present invention as shown in FIGS. 3 and 4 includes:

a hydraulic pump 1 connected to an engine (not shown);

a swing spool 3 installed on an upstream side of a center bypass path 5 that fluidically communicates with a discharge flow path 2 of the hydraulic pump 1 and configured to be shifted to control a start, a stop, and a direction change of a swing motor (not shown);

an arm spool 15 installed on a downstream side of the center bypass path 5 and configured to be shifted to control a start, a stop, and a direction change of an arm cylinder (not shown); and

a center bypass control valve 16 installed within the arm spool 15, the center bypass control valve being configured to be shifted by a pressure of a hydraulic fluid discharged from the hydraulic pump 1, which is increased during a combined operation in which a swing manipulation and an arm manipulation are simultaneously performed, and configured to unload an increased pressure on the swing side to the center bypass path 5 during the shift thereof.

In this case, the set pressure of the center bypass control valve 16 is set by an arm load pressure and is controlled to be linearly increased by a start pressure on the swing side according to a swing pilot pressure during the swing operation.

The center bypass control valve 16 includes:

a sleeve 18 installed within the arm spool 15 and having a flow path 17 formed therein so as to fluidically communicate with the discharge flow path 2 of the hydraulic pump 1;

a first piston 19 slidably installed within the sleeve 18 and configured to be shifted to maintain the arm side load pressure through unloading of a part of the discharged hydraulic fluid on the hydraulic pump 1 side to the center bypass path during the combined operation in which the swing manipulation and the arm manipulation are simultaneously performed;

a second piston 20 configured to be in close contact with one end of the first piston 19 and to be shifted to press the first piston 19 by the load pressure which is variably increased depending on a swing side pilot pressure that is additionally applied to the arm side load pressure during the combined operation in which the swing manipulation and the arm manipulation are simultaneously performed; and

a third piston 22 elastically installed on the other end of the first piston 19 by a valve spring 21.

The set pressure of the valve spring 21 that supports the third piston 22 is set to be larger than the load pressure on the hydraulic pump 1 side during the arm operation and is set to be smaller than the load pressure on the hydraulic pump 1 side during the swing operation.

A pair of center bypass path 24 and 25, which are formed in a bridge shape to fluidically communicate with each other in the hydraulic control valve 23 so that they fluidically communicate with the discharge flow path 2 of the hydraulic pump 1, fluidically communicate with the center bypass path 5 that fluidically communicates with the discharge flow path 2 of the hydraulic pump 1 via a path 26 formed on the arm spool 15 and the center bypass control valve 16.

The hydraulic pump 1 is controlled by a positive control system that controls the discharge flow rate of the hydraulic pump in proportion to the shift amount of the hydraulic control valve 23 (referring a spool of MCV) that is installed in the center bypass path 5.

The hydraulic pump 1 is controlled by a negative control system which controls the discharge flow rate of the hydraulic pump in reverse proportion to the pressure of the discharged hydraulic fluid, which is formed by a pressure forming means installed on the downstream side of the center bypass path 5.

Hereinafter, a use example of the hydraulic control valve for a construction machine in accordance with an embodiment of the present invention will be described in detail with reference to the accompanying drawings.

As shown in FIG. 3, in the case where a combined operation is carried out in which arm manipulation and a swing manipulation is performed simultaneously, the arm spool 15 is shifted in a left direction on the drawing sheet in response to an arm-in pilot signal pressure supplied to a port (al2). Thus, a hydraulic fluid discharged from the hydraulic pump 1 is supplied to a port (AL2) along a cylinder line 12 after passing through the shifted arm spool 15 via an orifice 11 of a parallel line 6 and a check valve 7 so that the hydraulic fluid is supplied to the non-illustrated arm cylinder to perform an arm-in operation.

In the meantime, the hydraulic fluid being supplied to the center bypass path 5 from the hydraulic pump 1 is supplied to only the parallel line 6 since the center bypass path 5 is in a state of being interrupted according to the shift of the arm spool 15.

At this time, a load pressure formed on the arm side is transferred to the pressure of the hydraulic pump 1 as it is, and a pressure is also formed on the center bypass path 5. This pressure is supplied to an inlet of the center bypass control valve 16 via a line 27, and simultaneously acts as a pressure that shifts the center bypass control valve 16 in a left direction on the drawing sheet through a path 28. The pressure that shifts the center bypass control valve 16 forms equilibrium with the valve spring 21. But, the set pressure of the valve spring 21 is previously set to be larger than the load pressure on the hydraulic pump 1 side during the arm operation and to be smaller than the load pressure on the hydraulic pump 1 side during the swing operation.

Meanwhile, when the arm operation is performed alone, the center bypass control valve 16 is operated, but when the arm and the swing operations are simultaneously performed, the swing spool 3 is shifted in a left direction on the drawing sheet by the pilot signal pressure supplied to the port (al1) so that the hydraulic fluid discharged from the hydraulic pump 1 is supplied to a port (AL1) via a line 8 after sequentially passing through the check valve 7 installed on an inlet line of the swing spool 3 and the shifted swing spool 3. This drives the swing motor to cause the upper swing structure of the construction machine to be swung.

In this case, since the hydraulic fluid returned to the swing motor is supplied to a port (BL1), it is returned to a hydraulic tank T through a return line 10 after passing through the shifted swing spool 3 via a line 9 so that the arm operation and the swing operation can be simultaneously performed.

In the meantime, since the arm spool 15 is in a state of having been shifted completely, the center bypass path 5 has also been interrupted. For this reason, a pressure of the hydraulic pump 1 is also increased gradually due to an increase in the discharged hydraulic fluid of the hydraulic pump side according to a manipulation amount of a manipulation lever. But, when the pilot signal pressure is supplied to the port (al1), it is transferred to the third piton 22 adjacent to the center bypass control valve 16 via a shuttle valve 30 and a pilot line 31.

Like this, when the pressure is transferred to the third piston 22, a swing pilot pressure applied to the port (al1) is variably transferred to the cross section of the third piston 22 with respect to an elastic force of the valve spring 21 that is set to be large than the arm side pressure at the right side of the third piston 22. The load pressure is variably increased depending on the swing side pilot pressure, which is additionally applied to the initial arm side load pressure.

At this time, the swing side pilot pressure applied to the hydraulic pump 1 shifts the center bypass control valve 16 in the left direction on the drawing sheet as it is sufficiently large. Thus, the hydraulic fluid having passed through the center bypass path 5 of the swing spool 3 is unloaded to the center bypass path 5 via the arm spool 15 through a line 32 after passing through the shifted center bypass control valve 16, and thus is returned to a hydraulic tank T.

As shown in FIG. 4, when an arm-in pilot signal pressure is supplied to a port (a), the pilot signal pressure transferred to the arm spool 15 exceeds the elastic force of the valve spring 33 to cause the arm spool 15 to be shifted in the right direction on the drawing sheet. Since the hydraulic fluid supplied from the discharge flow path 2 presses a poppet 34 in an upward direction on the drawing sheet, it is supplied to the parallel line 35. Simultaneously, the hydraulic fluid supplied to the discharge flow path 2 presses the poppet 38 via the orifice 37 of a plug 36. For this reason, the hydraulic fluid that presses the poppet 38 joins the hydraulic fluid flowing in the parallel line 35 via a groove formed on the slidable outer surface of the poppet 38, and then is supplied to the cylinder line 12 via a spool notch 39 formed on the arm spool 15. Thus, the hydraulic fluid supplied to the cylinder line 12 is supplied to a non-illustrated arm cylinder via the port (AL2) to perform an arm-in operation. The hydraulic fluid returned from the arm cylinder is supplied to the cylinder line 13 via a port (BL2), and thus is returned to the hydraulic tank through a tank line 50 via the spool notch 40 formed on the shifted arm spool 15.

The operation of the center bypass control valve 16 installed within the arm spool 15 shifted in the right direction on the drawing sheet will be described hereinafter.

The pressure of the discharge flow path 2 is supplied to a groove 19a of the first piston 19 through a path 42 formed in the sleeve 18 via a flow path 41 formed in the arm spool 15. The center bypass paths 24 and 25 are formed in a bridge shape to fluidically communicate with each other in the hydraulic control valve 23 so that the pressure supplied from the hydraulic pump 1 is uniformly applied to the center bypass paths 24 and 25. When the pressure from the hydraulic pump 1 is applied to the center bypass path 24, it is supplied to a spool notch 43 of the shifted arm spool 15 and a line 28 so that it presses the left side of the second piston 20 that is in close contact with the first piston 19 while sliding within the sleeve 18.

The second piston 20 must exceed the elastic force of the valve spring 21 that is disposed adjacent to a plug 44 and is supported by the third piston 22 in order to be shifted in the right direction on the drawing sheet. In this case, when an initial control pressure of the valve spring 21 is set to about the load pressure (60-80 Kgf/cm²) of the arm and then exceeds the set pressure, the second piston 20 is shifted in the right direction on the drawing sheet. At this time, as the first piston 19 is shifted in the right direction on the drawing sheet, the pressure of the hydraulic pump is applied to the groove 19a of the first piston 19 so that the groove 19a fluidically communicates with the flow path 17 of the sleeve 18, and then fluidically communicates with the center bypass path 25 via the line 26 of the arm spool 15. Then, the center bypass path 25 fluidically communicates with the center bypass path 24 in a bridge shape in the hydraulic control valve 23 so that the hydraulic fluid is bypassed and is returned to the hydraulic tank. In other words, a part the hydraulic fluid on the hydraulic pump 1 side is unloaded to the center bypass path 5 so that the arm side load pressure can be constantly maintained.

In the meantime, in the case where a combined operation is carried out in which arm manipulation and a swing manipulation is performed simultaneously, the swing pilot pressure is supplied to the pocket 45 via the line 31 while being supplied to a swing port (sw), and is applied to the right end of the third piston 22 via the line 46 of the arm spool 15 shifted in the right direction on the drawing sheet to compress the valve spring 21. For this reason, the load pressure is variably increased depending on the swing side pilot pressure that is additionally applied to the initially set arm load pressure.

Meanwhile, similarly to the arm-in operation alone, a sufficiently high load pressure applied to the hydraulic pump 1 according to the swing operation is applied to the left side of the second piston 20 installed within the shifted arm spool 15. In this case, the high load pressure exceeds the load pressure which is variably increased depending on a swing side pilot pressure that is additionally applied to the arm side load pressure. Then, when the second piston 20 is shifted in the right direction on the drawing sheet, the first piston 19 is also shifted to the right. Similarly, the pressure from the hydraulic pump 1 is applied to the groove 19a of the first piston 19 so that the groove 19a fluidically communicates with the flow path 17 of the sleeve 18, and then fluidically communicates with the center bypass path 25 via the line 26 of the arm spool 15. Then, the center bypass path 25 fluidically communicates with the center bypass path 24 in a bridge shape in the hydraulic control valve 23 so that the hydraulic fluid is bypassed and is returned to the hydraulic tank. In other words, a part the hydraulic fluid on the hydraulic pump 1 side is unloaded to the center bypass path 5 so that an overload according to the swing operation can be prevented and the swing side load pressure can be maintained variably in proportion to the swing pilot pressure.

For this reason, the excessive increase of pressure on the hydraulic pump side can be prevented to reduce over-consumption of horsepower and loss of energy and thus improve a fuel efficiency.

Thus, in case of the negative control system, a swivel angle of swash plate of the hydraulic pump is reduced owing to an increase in the negative control pressure according to an increase in the center bypass flow rate so that the discharge flow rate of the hydraulic pump can be decreased, thereby preventing an excessive increase in the pressure of the hydraulic pump.

On the other hand, in case of the positive control system, the hydraulic fluid from the hydraulic pump increased according to an increase in the manipulation amount is unloaded to the center bypass path so that excessive increase in the pressure of the hydraulic pump is prevented. In addition, when the arm operation and the swing operation are performed simultaneously, an excessive increase in the pressure of the hydraulic pump according to the interception of the center bypass path can be prevented. In this case, the center bypass control valve is installed within the arm spool so that a hydraulic fluid discharged from the high load hydraulic pump is unloaded to the center bypass path without any interception of the center bypass path when the swing manipulation and the swing manipulation are simultaneously performed, thereby preventing an excessive increase in the pressure of the hydraulic pump and thus reducing a loss of energy.

While the present invention has been described in connection with the specific embodiments illustrated in the drawings, they are merely illustrative, and the invention is not limited to these embodiments. It is to be understood that various equivalent modifications and variations of the embodiments can be made by a person having an ordinary skill in the art without departing from the spirit and scope of the present invention. Therefore, the true technical scope of the present invention should not be defined by the above-mentioned embodiments but should be defined by the appended claims and equivalents thereof.

### INDUSTRIAL APPLICABILITY

As described above, hydraulic control valve for a construction machine in accordance with an embodiment of the present invention, in the hydraulic control valve in which the swing spool is installed on the upstream of the center bypass path and the arm spool is installed on the downstream thereof, and the discharge flow rate is controlled by the positive control system, the center bypass control valve is installed within the arm spool so that a hydraulic fluid discharged from a high-load hydraulic pump is unloaded to the center bypass path through the center bypass control valve during a combined operation in which the swing manipulation and the manipulation of a work apparatus such as an arm or the like are simultaneously performed, thereby reducing the high load pressure generated from the hydraulic pump and thus decreasing a loss of energy.

1. A hydraulic control valve for a construction machine, comprising:
a hydraulic pump connected to an engine;
a swing spool installed on an upstream side of a center bypass path that fluidically communicates with a discharge flow path of the hydraulic pump 1 and configured to be shifted to control a start, a stop, and a direction change of a swing motor;
an arm spool installed on a downstream side of the center bypass path and configured to be shifted to control a start, a stop, and a direction change of an arm cylinder; and
a center bypass control valve 16 installed within the arm spool, the center bypass control valve being configured to be shifted by a pressure of a hydraulic fluid discharged from the hydraulic pump, which is increased during a combined operation in which a swing manipulation and an arm manipulation are simultaneously performed, and configured to unload an increased pressure on the swing side to the center bypass path during the shift thereof.

2. The hydraulic control valve for a construction machine according to claim 1, wherein the set pressure of the center bypass control valve is set by an arm load pressure and is controlled to be linearly increased by a start pressure on the swing side according to a swing pilot pressure during the swing operation.

3. The hydraulic control valve for a construction machine according to claim 1, wherein the center bypass control valve comprises:
a sleeve installed within the arm spool and having a flow path formed therein so as to fluidically communicate with the discharge flow path of the hydraulic pump;
a first piston slidably installed within the sleeve 18 and configured to be shifted to maintain the arm side load pressure through unloading of a part of the discharged hydraulic fluid on the hydraulic pump side to the center bypass path during the combined operation in which the swing manipulation and the arm manipulation are simultaneously performed;
a second piston configured to be in close contact with one end of the first piston and to be shifted to press the first piston by the load pressure which is variably increased depending on a swing side pilot pressure that is additionally applied to the arm side load pressure during the combined operation in which the swing manipulation and the arm manipulation are simultaneously performed; and
a third piston elastically installed on the other end of the first piston by a valve spring.

4. The hydraulic control valve according to claim 1, wherein the set pressure of the valve spring that supports the third piston is set to be larger than the load pressure on the hydraulic pump side during the arm operation and is set to be smaller than the load pressure on the hydraulic pump side during the swing operation.

5. The hydraulic control valve according to claim 1, wherein a pair of center bypass path, which are formed in a bridge shape to fluidically communicate with each other in the hydraulic control valve so that they fluidically communicate with the discharge flow path of the hydraulic pump, fluidically communicate with the center bypass path that fluidically communicates with the discharge flow path of the hydraulic pump via a path formed on the arm spool and the center bypass control valve.

6. The hydraulic control valve according to claim 1, wherein the hydraulic pump is controlled by a positive control system that controls the discharge flow rate of the hydraulic pump in proportion to the shift amount of the hydraulic control valve that is installed in the center bypass path.

7. The hydraulic control valve according to claim 1, wherein the hydraulic pump is controlled by a negative control system that controls the discharge flow rate in reverse proportion to the pressure of the discharged hydraulic fluid, which is formed by a pressure forming means installed on the downstream side of the center bypass path.
